(19) United States
(12) Patent Application Publication
(10) Pub. No.: US 2026/0087134 A1
(43) Pub. Date: Mar. 26, 2026

(54) COUNTERMEASURES FOR BACKDOOR ATTACKS OF DEEP LEARNING SYSTEMS

(71) Applicant: VINAI ARTIFICIAL INTELLIGENCE APPLICATION AND RESEARCH JOINT STOCK COMPANY, Ha Noi (VN)

(72) Inventors: Tuan Anh Tran, Ha Noi (VN); Ngoc Tran Huynh, Ha Noi (VN); Dang Khoa Doan, Ha Noi (VN); Huy Tung Pham, Ha Noi (VN); Hai Hung Bui, Ha Noi (VN)

(21) Appl. No.: 18/892,934

(22) Filed: Sep. 23, 2024

Related U.S. Application Data
(60) Provisional application No. 63/697,361, filed on Sep. 20, 2024.

(51) Int. Cl. G06F 21/56; G06N 20/00

(52) U.S. Cl. CPC G06F 21/566; G06N 20/00; G06F 2221/034

(57) ABSTRACT

Training countermeasures for a backdoor attack on a deep learning model is provided. The method includes defining a maximum learning rate and a minimum learning rate to train the deep learning model against backdoor attacks. The subject model is initialized to run a learning process using the minimum learning rate. The learning process of the deep learning model is cycled through the maximum learning rate and the minimum learning rate. The cycling process is interleaved using a first data set of clean data and a second data set of poisoned data until a threshold value of defense is reached.

### CROSS-REFERENCE TO RELATED APPLICATION

This application claims the benefit of priority of U.S. provisional patent application No. 63/697,361, filed Sep. 20, 2024, the contents of which are herein incorporated by reference.

### FIELD OF THE INVENTION

The present invention relates in general to machine learning systems. More particularly, the invention is directed to countermeasures for backdoor attacks of deep learning systems.

### BACKGROUND OF THE INVENTION

Deep learning has become essential in most modern AI systems thanks to its outstanding performance in almost every task. However, developing high-performing deep learning models (DNNs) is costly; it often requires a large set of training data, expensive and advanced hardware, and lengthy training time. Therefore, using pretrained models provided by third parties become a popular practice.

Non-expert customers may acquire and deploy the pretrained models as is, while expert customers can finetune those models using their own data for the target tasks. Those open a loophole for backdoor attacks, an emerging security threat that has drawn increasing attention in recent years. Backdoor attacks are training time attacks that fool deep neural networks (DNNs) into misclassifying inputs containing a specific trigger, thus representing serious security risks.

Some research in the field has demonstrated that by injecting a backdoor trigger, i.e., a specific pre-defined pattern such as a small square, to a small portion of the training data, the trained model will misclassify when facing inputs with the presence of this trigger. In contrast, on benign inputs, the poisoned model still behaves normally, which makes the attack hard to detect. The adversary can fool customers into deploying such a backdoor model in their systems, then use inputs with the backdoor trigger to manipulate the model's outputs for gaining illegal benefits or causing awful damage. As the research in this field has progressed, the attacks have become more powerful and sophisticated. More recent methods are capable of utilizing stealthier triggers that are visually imperceptible

As a countermeasure against backdoor attacks, various backdoor defenses have been introduced. Existing defenses have made substantial efforts to detect and mitigate the effects of backdoor attacks using various approaches, such as inverting triggers, splitting datasets, pruning the DNNs, or adversarial unlearning. While sophisticated defense techniques like unlearning and pruning effectively mitigate backdoors, they often come at the cost of sacrificing accuracy on the original tasks. Conversely, fine-tuning-based defense offers a more balanced approach, partially restoring the model's utility. However, vanilla fine-tuning alone provides only modest backdoor mitigation. Therefore, fine-tuning is often combined with other defense mechanisms to achieve superior defense performance.

### SUMMARY OF THE INVENTION

In one aspect of the subject technology, a method of training countermeasures for a backdoor attack on a deep learning model is provided. The method includes defining a maximum learning rate and a minimum learning rate to train the deep learning model against backdoor attacks. The subject model is initialized to run a learning process using the minimum learning rate. The learning process of the deep learning model is cycled through the maximum learning rate and the minimum learning rate. The cycling process is interleaved using a first data set of clean data and a second data set of poisoned data until a threshold value of defense is reached.

In another aspect of the subject technology, a computer program product for training countermeasures for a backdoor attack on a deep learning model is provided. The computer program product comprises a computer readable storage medium having program instructions embodied therewith. An execution of the program instructions cause a computer processor to define a maximum learning rate and a minimum learning rate to train the deep learning model against backdoor attacks. The subject model is initialized to run a learning process using the minimum learning rate. The learning process of the deep learning model is cycled the maximum learning rate and the minimum learning rate.

The cycling process is interleaved using a first data set of clean data and a second data set of poisoned data until a threshold value of defense is reached.

In yet another aspect, a computing server is provided. The computing server is configured to train countermeasures against a backdoor attack on a neural network model. The computing server includes a computer processor operating a backdoor model countermeasure training engine. A memory is coupled to the computer processor. The memory stores instructions to cause the computer processor to perform acts including defining a maximum learning rate and a minimum learning rate to train the deep learning model against backdoor attacks. The subject model is initialized to run a learning process using the minimum learning rate. The learning process of the deep learning model is cycled the maximum learning rate and the minimum learning rate. The cycling process is interleaved using a first data set of clean data and a second data set of poisoned data until a threshold value of defense is reached.

These and other features and advantages of the invention will become more apparent with a description of preferred embodiments in reference to the associated drawings.

### DESCRIPTION OF THE DRAWINGS

FIG. 1 is a block diagram of a system for training countermeasures for a backdoor attack on a deep learning model in accordance with an embodiment of the subject technology.

FIG. 2 is a diagrammatic view of a training method in accordance with an embodiment of the subject technology.

FIG. 3 is a diagrammatic view of a loss landscape for the training method of FIG. 2, in accordance with an embodiment of the subject technology.

FIG. 4 is a flowchart of a method for training countermeasures for a backdoor attack on a deep learning model in accordance with an embodiment of the subject technology.

### DETAILED DESCRIPTION OF THE PREFERRED EMBODIMENTS

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. Like or similar components are labeled with identical element numbers for ease of understanding.

### Overview

In general, and referring to the Figures, embodiments provide training countermeasures for a backdoor attack on a deep learning model. Aspects of the subject technology counter fine-tuning techniques that attempt to counter backdoor attack defenses in deep learning models. A backdoor modeling process is disclosed that can make the backdoor unforgettable after undergoing finetuning techniques.

### Definitions

Neural network, as used herein, refers to a computational learning system that uses a network of functions to understand and translate a data input of one form into a desired output.

Deep Learning Modeling, as used herein, refers to a subset of machine learning that uses multilayered neural networks, called deep neural networks, to simulate the complex decision-making power of the human brain.

Backdoor or Backdoor attack, as used herein refers to when an attacker subtly alters A.I. models during training, causing unintended behavior under certain triggers.

Interleave, as used herein, refers to performing a process in alternating occurrences.

Finetune, as used herein, refers to transferring learning in which the parameters of a pre-trained model are trained on new data. Fine-tuning can be done on the entire neural network, or on only a subset of its layers.

Poisoned, as used herein, refers to data for deep-learning training which is compromised with intentional malicious information.

### EMBODIMENTS

### System Architecture

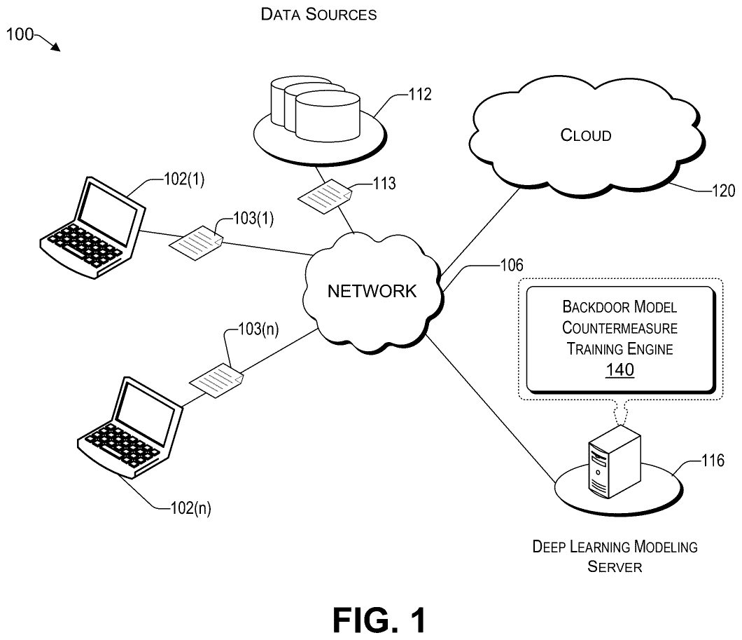

FIG. 1 shows a system 100 (referred to generally below as the “system 100” or just the “system”) for training countermeasures for a backdoor attack on a deep learning model according to an embodiment. The system 100 generally includes one or more computing device nodes 102(1) . . . 102(n) connected through a network 106 to a data sources 112. Other elements connected to the network 106 and to the computing device nodes 102(1) . . . 102(n), include a deep learning modeling server 116, and in some embodiments, the cloud 120.

The deep learning modeling server 116 may include a backdoor model countermeasure training engine 140 providing model training to counter backdoor attacks using the techniques described below. The network 106 allows the backdoor model countermeasure training engine 140, which is a software program running on deep learning modeling server 116, to communicate with the data source 112, computing device nodes 102(1) . . . 102(n), and/or the cloud 120, to provide processing of data used to train a deep learning model to be resistant to backdoor attacks. The data sources 112 may include clean data and poisoned data used for training. Input from computing device nodes 102(1) . . . 102(n) may take the form of data packets 103(1) . . . 103(n) that are transferred into the network 106 and forwarded to the data sources 112 for retrieval of stored data 113, and/or the deep learning modeling server 116, and or the cloud 120 for processing of input to generate modeling. In one embodiment, the data processing is performed at least in part within the cloud network 120.

The components of the computing device nodes 102(1) . . . 102(n) and server 116 may include, but are not limited to, one or more computer processors, a system memory, data storage, and a computer program product having a set of program modules including files and executable instructions performing any one or more of the methods included in this disclosure. The computing devices may typically include a variety of computer system readable media. Such media could be chosen from any available media that is accessible including non-transitory, volatile and non-volatile media, removable and non-removable media for use by or in connection with an instruction execution system, apparatus, or device. The system memory may include one or more computer system readable media in the form of volatile memory, such as a random-access memory (RAM) and/or a cache memory.

As will be appreciated by one skilled in the art, aspects of the disclosed technology may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “module”, “circuit”, or “system.” In addition, some embodiments below are described with reference to block diagrams of methods, apparatus (systems) and computer program products. It will be understood that each block of the block diagrams, and combinations of blocks in the flowchart illustrations and/or block diagrams, can be implemented by computer program instructions. These computer program instructions may be provided to the processor/controller 105, such that the instructions, which execute via the processor of the computer or other programmable data processing apparatus, create means for implementing the functions/acts specified in the flowchart and/or block diagram block or blocks in the figures.

### Countering Finetuning Methodology

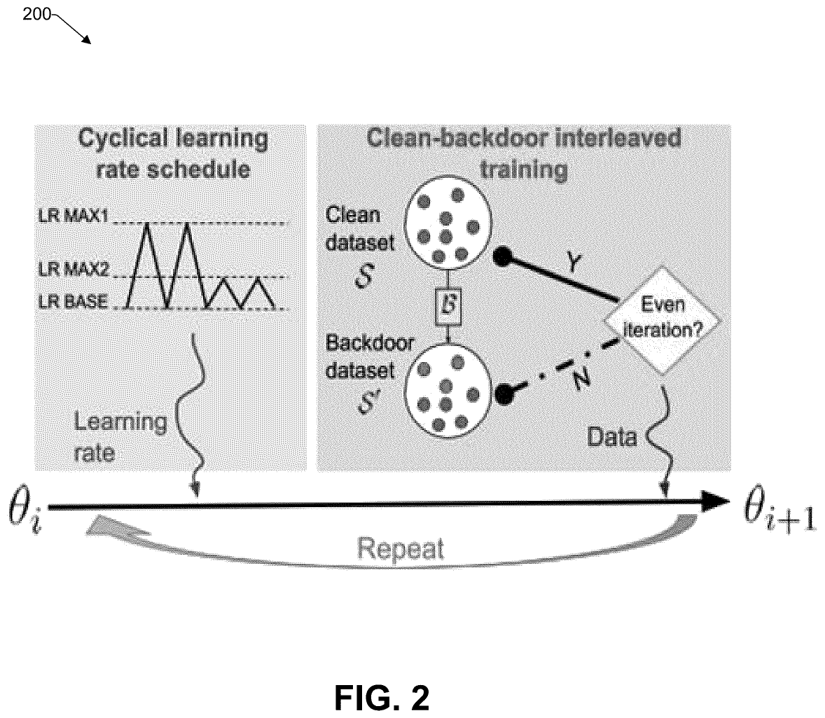

FIG. 2 shows a training method 200 according to an embodiment. The training method 200 generally changes the learning rate cyclically during backdoor model training. As background, one should consider the attack optimization problem:

$${θ}_{bd} = arg {min}_{θ} {\sum }_{( {x}^{′} , {y}^{′} ) ∈ {S}^{′}} ℒ ( {f}_{θ} ( {x}^{′} ) , {y}^{′} ) . \qquad eq ( 1 )$$

Using with initial model weights θ₀=θ_{bd}. After t updating steps, we obtain θₜ₊₁ from θₜ as follows:

$${θ}_{t + 1} = {θ}_{t} - ϵ {∇}_{θ} {ℒ}_{bd} ( {θ}_{t} ) , \qquad eq ( 2 )$$

where ϵ is the learning rate, and L_{bd}(θt) is the loss function's value on the poisoned data set. Instead of using the same e as in the common backdoor training, the learning rate may be varied using a designed schedule that may comprise two phases.

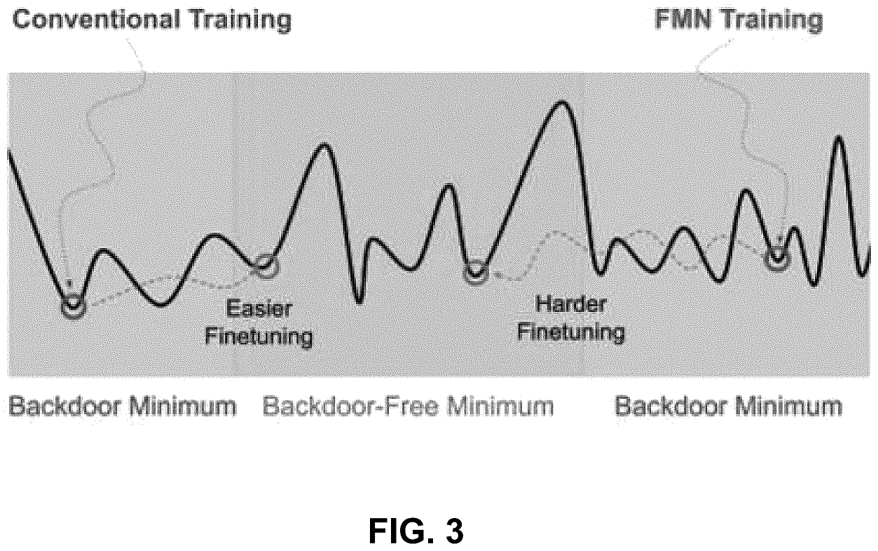

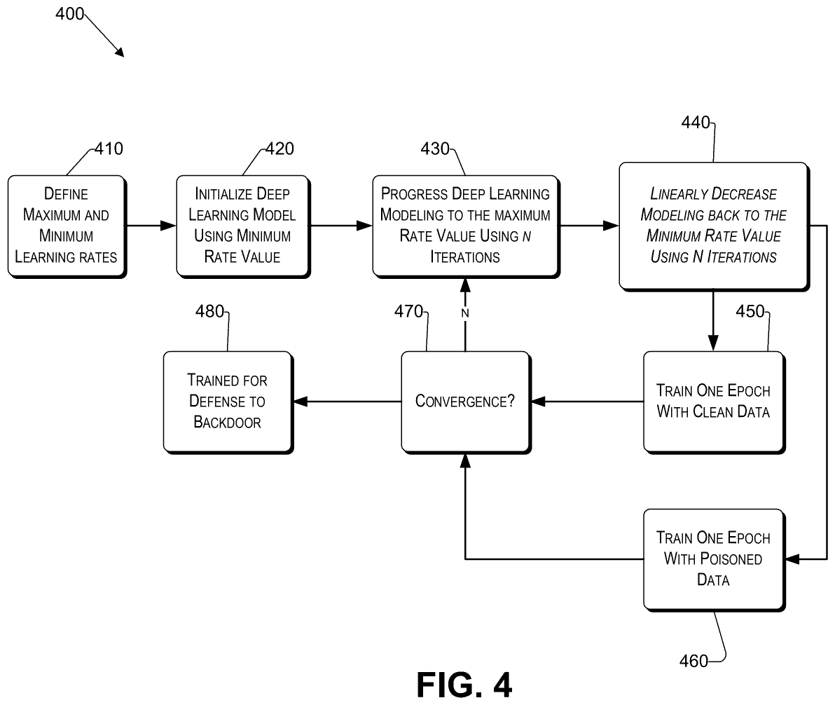

The additional discussion of FIG. 2 that follows is meant to be described with concurrent references to FIGS. 3 and 4. FIG. 3 shows a loss landscape of training values during model training to counter backdoor attacks under the subject technology. FIG. 4 provides a flowchart of steps used in a method 400 for training countermeasures for a backdoor attack on a deep learning model in accordance with an embodiment that is consistent with the discussion related to FIG. 2. References to block numbers in the following discussion are associated with the blocks shown in FIG. 4.

In the first phase shown in FIG. 2, a maximum learning rate and a minimum learning rate may be defined (block 410). The deep learning model may be initialized with the minimum learning rate value (block 420). The deep learning model may be progressed linearly increases the output to the maximum value in n iterations (block 430). In some embodiments, the deep learning model may then be linearly decreased back to the minimum learning rate value for another n iterations (block 440). Blocks 430 and 440 may represent a finetuning of the learning process, which in some embodiments may be repeated several times in this phase (labeled as the “cyclical learning rate schedule” in FIG. 2).

The second phase is similar to the first one, except that a smaller maximum learning rate value may be used. By training the poisoned model with cyclical learning rates, the backdoor is exposed to a wider range of learning rates during training, thus allowing it to be more robust to changes in the learning rate. Consequently, the backdoor becomes harder to remove, even when using advanced finetuning methods such as super-finetuning.

A goal of finetuning defenses is to find an alternative local minimum that is free of the backdoor while preserving the model's utility. Cyclical backdoor training can be viewed as searching for a region within the loss landscape where it is difficult for finetuning defenses to find these alternative local minima, as visually described in FIG. 3. In essence, this region primarily consists of local minima that are full of backdoors that can be exploited. Local minima represent points where the backdoor's efficacy diminishes. “FMN” training in the figure refers to the subject technology. As can be seen, the occurrence of local minima under the subject technology increases making it more difficult to identify these local minima points of vulnerability.

Referring back to the methods 200 and 400, to further strengthen the backdoor's resistance against finetuning defenses, clean-backdoor interleaved training is included in the subject technology. Training the backdoor with the cyclical learning rate is performed while additionally emulating the finetuning process during such training. In one embodiment, the deep learning model is trained with a clean dataset (FIG. 2) for one epoch (block 450). In some embodiments, the deep learning model may be alternately trained using a poisoned dataset (FIG. 2) for one epoch (block 460). In some embodiments, the training using the clean data may be followed up with a cycle of finetuning (blocks 430 and 440) before interleaving training the model with the poisoned data. After each training instance (which may be after one epoch of clean data, or one epoch of poisoned data, or after training with one each of clean and poisoned data), the deep learning model output may be checked after each cycle for convergence (block 470). Intuitively, this approach allows the backdoor training process to form an even harder region to penetrate with attacks in a hybrid loss landscape (as represented by the right-side, one-third section of FIG. 3). When convergence is reached, the deep learning model may be considered to have reached a threshold level of defense to backdoor attacks (block 480). Accordingly, it should be appreciated that the processes disclosed herein provide improved resiliency against fine-tuning defenses, confirming the subject technology's ability to search for a difficult backdoor region for these defenses to break away from.

Those of skill in the art would appreciate that various components and blocks may be arranged differently (e.g., arranged in a different order, or partitioned in a different way) all without departing from the scope of the subject technology. The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects.

Thus, the claims are not intended to be limited to the aspects shown herein, but are to be accorded the full scope consistent with the language of claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A method of training countermeasures for a backdoor attack on a deep learning model, comprising:
defining a maximum learning rate and a minimum learning rate to train the deep learning model against backdoor attacks;
initializing the subject model to run a learning process using the minimum learning rate;
cycling the learning process of the deep learning model through the maximum learning rate and the minimum learning rate; and
interleaving the cycling of the learning process using a first data set of clean data and a second data set of poisoned data until a threshold value of defense is reached.

2. The method of claim 1, wherein the interleaving step includes alternating the use of the clean data for one epoch of training with the use of the poisoned data for one epoch of training.

3. The method of claim 2, wherein the interleaving step is performed until a convergence of the threshold value of defense is reached.

4. The method of claim 3, further comprising:
determining whether the convergence of the threshold value of defense is reached after each epoch of training; and
repeating the finetuning process before a next epoch of training using either the clean data set or the poisoned data set in the event that convergence of the threshold value is not reached.

5. The method of claim 4, further comprising determining that the deep learning model is trained for a defense to backdoor attacks in the event that convergence of the threshold value of defense is reached after one or more of the epochs of training.

6. The method of claim 1, wherein the cycling step includes progressing the learning process until the deep learning model uses the maximum learning rate before performing the interleaving step.

7. The method of claim 6, further comprising linearly decreasing the learning process until the deep learning model returns to the minimum learning rate before performing the interleaving step.

8. A computer program product for training countermeasures for a backdoor attack on a neural network model, the computer program product comprising a computer readable storage medium having program instructions embodied therewith, wherein an execution of the program instructions by a computer processor cause a computing device to:
receive definitions of a maximum learning rate and a minimum learning rate to train the deep learning model against backdoor attacks;
initialize the subject model to run a learning process using the minimum learning rate;
cycle the learning process of the deep learning model through the maximum learning rate and the minimum learning rate; and
interleave the cycling of the learning process using a first data set of clean data and a second data set of poisoned data until a threshold value of defense is reached.

9. The computer program product of claim 8, wherein the execution of the program instructions further causes the computing device to alternate the use of the clean data for one epoch of training with the use of the poisoned data for one epoch of training, during the interleaving step.

10. The computer program product of claim 8, wherein the execution of the program instructions further causes the computing device to perform the interleaving step until a convergence of the threshold value of defense is reached.

11. The computer program product of claim 10, wherein the execution of the program instructions further causes the computing device to:
determine whether the convergence of the threshold value of defense is reached after each epoch of training; and
repeat the cycling process before a next epoch of training using either the clean data set or the poisoned data set in the event that convergence of the threshold value is not reached.

12. The computer program product of claim 11, wherein the execution of the program instructions further causes the computing device to determine that the deep learning model is trained for a defense to backdoor attacks in the event that convergence of the threshold value of defense is reached after one or more of the epochs of training.

13. The computer program product of claim 8, wherein the execution of the program instructions further causes the computing device to progress the learning process until the deep learning model uses the maximum learning rate before performing the interleaving step.

14. The computer program product of claim 13, wherein the execution of the program instructions further causes the computing device to linearly decrease the learning process until the deep learning model returns to the minimum learning rate before performing the interleaving step.

15. A computing server configured to train countermeasures against a backdoor attack on a neural network model, comprising:
a computer processor operating a backdoor model countermeasure training engine; and
a memory coupled to the computer processor, the memory storing instructions to cause the computer processor to perform acts comprising:
defining a maximum learning rate and a minimum learning rate to train the deep learning model against backdoor attacks;
initializing the subject model to run a learning process using the minimum learning rate;
cycling the learning process of the deep learning model through the maximum learning rate and the minimum learning rate; and
interleaving the cycling of the learning process using a first data set of clean data and a second data set of poisoned data until a threshold value of defense is reached.

16. The computing server of claim 15, wherein the instructions cause the processor to perform further acts comprising alternating the use of the clean data for one epoch of training with the use of the poisoned data for one epoch of training, during the interleaving step.

17. The computing server of claim 15, wherein the instructions cause the processor to perform further acts comprising performing the interleaving step until a convergence of the threshold value of defense is reached.

18. The computing server of claim 15, wherein the instructions cause the processor to perform further acts comprising:
determining whether the convergence of the threshold value of defense is reached after each epoch of training; and
repeating the cycling process before a next epoch of training using either the clean data set or the poisoned data set in the event that convergence of the threshold value is not reached.

19. The computing server of claim 15, wherein the instructions cause the processor to perform further acts comprising progressing the learning process until the deep learning model uses the maximum learning rate before performing the interleaving step.

20. The computing server of claim 19, wherein the instructions cause the processor to perform further acts comprising linearly decreasing the learning process until the deep learning model returns to the minimum learning rate before performing the interleaving step.
